(19) United States
(12) Patent Application Publication
(10) Pub. No.: US 2006/0153215 A1
(43) Pub. Date: Jul. 13, 2006

(54) Connection context prefetch

(76) Inventors: Linden Cornett, Portland, OR (US); Prafulla Deuskar, Hillsboro, OR (US); David B. Minturn, Hillsboro, OR (US); Sujoy Sen, Portland, OR (US); Anil Vasudevan, Portland, OR (US)

Correspondence Address: INTEL CORPORATION, P.O. BOX 5326, SANTA CLARA, CA, 95056-5326, US

(21) Appl. No.: 11/018,448

(22) Filed: Dec. 20, 2004

(51) Int. Cl. H04L 12/56

(52) U.S. Cl. 370/412

(57) ABSTRACT

In an embodiment, a method is provided. The method of this embodiment provides associating a receive packet with a selected one of a plurality of buckets in a table using a generated value based, at least in part, on the receive packet, and obtaining a connection context from the selected bucket. Other embodiments are disclosed and/or claimed.

### FIELD

Embodiments of this invention relate to connection context prefetch.

### BACKGROUND

A connection may specify a physical or a logical channel for the exchange of data and/or commands between systems, and may be defined by a connection context. As used herein, a “connection context” refers to information that may be used by a computer to manage information about a particular connection. For example, when a transmitting computer establishes a connection with a receiving system, the connection context may comprise one or more connection parameters including, for example, source address, destination address, local port, remote port, and sequence number for each direction. A connection context may be accessed during packet processing, when a packet may be parsed for information that may include one or more connection parameters related to the connection.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 illustrates a system according to an embodiment.

FIG. 2 illustrates a table according to an embodiment.

FIG. 3 is a flowchart illustrating a method according to an embodiment.

### DETAILED DESCRIPTION

Examples described below are for illustrative purposes only, and are in no way intended to limit embodiments of the invention. Thus, where examples may be described in detail, or where a list of examples may be provided, it should be understood that the examples are not to be construed as exhaustive, and do not limit embodiments of the invention to the examples described and/or illustrated.

One or more methods described herein may be performed in a Microsoft® Windows® operating system on which Receive Side Scaling (hereinafter “RSS”) technology of the Network Device Interface Specification (hereinafter “NDIS”) may be implemented (hereinafter referred to as “RSS environment”): NDIS is a Microsoft® Windows® device driver that enables a single network adapter, such as a NIC (network interface card), to support multiple network protocols, or that enables multiple network adapters to support multiple network protocols. The current version of NDIS is NDIS 5.1, and is available from Microsoft® Corporation of Redmond, Wash. A subsequent version of NDIS, known as NDIS 5.2 available from Microsoft® Corporation, which is to be part of the new version of Microsoft® Windows® currently known the “Scalable Networking Pack” for Windows Server 2003, includes various technologies not available in the current version.

For example, NDIS 5.2 includes technology known as Receive Side Scaling (hereinafter “RSS”). RSS enables receive-processing to scale with the number of available computer processors by allowing the network load from a network adapter to be balanced across multiple processors. RSS is further described in “Scalable Networking: Eliminating the Receive Processing Bottleneck—Introducing RSS”, WinHEC (Windows Hardware Engineering Conference) 2004, Apr. 14, 2004 (hereinafter “the WinHEC Apr. 14, 2004 white paper”). However, embodiments of the invention are not limited to NDIS and RSS implementations, as NDIS and RSS implementations are discussed and/or illustrated herein to provide an example of how embodiments of the invention may operate. Embodiments of the invention are generally applicable to any type of environment.

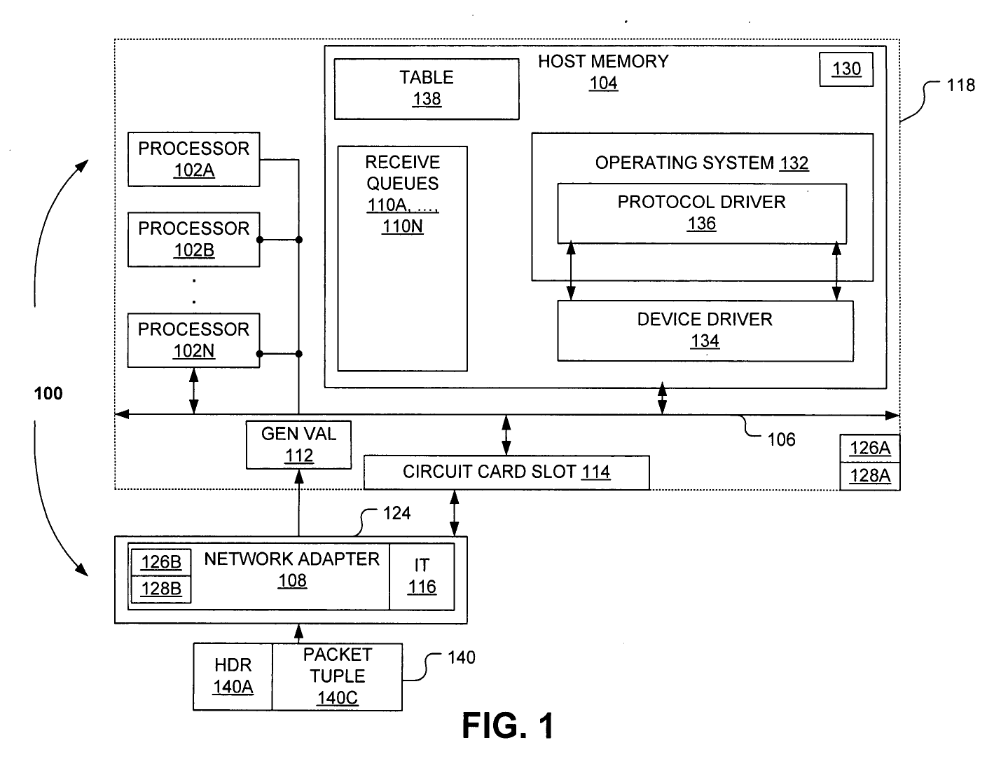

FIG. 1 illustrates a system in an embodiment. System 100 may comprise one or more processors 102A, 102B, . . . , 102N, host memory 104, bus 106, and network adapter 108. System 100 may comprise more than one, and other types of memories, buses, and network adapters; however, those illustrated are described for simplicity of discussion. Processors 102A, 102B, . . . , 102N, host memory 104, and bus 106, may be comprised in a single circuit board, such as, for example, a system motherboard 118.

System 100 may comprise circuitry 126A, 126B, which may comprise one or more circuits, to perform operations described herein. Circuitry 126A, 126B may be hardwired to perform the one or more operations. For example, circuitry 126A, 126B may comprise one or more digital circuits, one or more analog circuits, one or more state machines, programmable circuitry, and/or one or more ASIC's (Application-Specific Integrated Circuits). Alternatively, circuitry 126A, 126B may execute machine-executable instructions 130 to perform these operations. For example, circuitry 126A, 126B may comprise computer-readable memory 128A, 128B having read only and/or random access memory that may store program instructions, similar to machine-executable instructions 130.

Each processor 102A, 102B, . . . , 102N may be a coprocessor. In an embodiment, one or more processors 102A, 102B, . . . , 102N may perform substantially the same functions. Any one or more processors 102A, 102B, . . . , 102N may comprise, for example, an Intel® Pentium® microprocessor that is commercially available from the Assignee of the subject application. Of course, alternatively, any of processors 102A, 102B, . . . , 102N may comprise another type of processor, such as, for example, a microprocessor that is manufactured and/or commercially available from Assignee, or a source other than the Assignee of the subject application, without departing from embodiments of the invention.

Bus 106 may comprise a bus that complies with the Peripheral Component Interconnect (PCI) Local Bus Specification, Revision 2.2, Dec. 18, 1998 available from the PCI Special Interest Group, Portland, Oreg., U.S.A. (hereinafter referred to as a “PCI bus”). Alternatively, for example, bus 106 may comprise a bus that complies with the PCI Express Base Specification, Revision 1.0a, Apr. 15, 2003 available from the PCI Special Interest Group (hereinafter referred to as a “PCI Express bus”). Bus 106 may comprise other types and configurations of bus systems.

Network adapter 108 may be comprised in a circuit card 124 that may be inserted into a circuit card slot 114. Network adapter 108 may comprise circuitry 126B to perform operations described herein as being performed by network adapter 108 and/or system 100. When circuit card 124 is inserted into circuit card slot 114, PCI bus connector (not shown) on circuit card slot 114 may become electrically and mechanically coupled to PCI bus connector (not shown) on circuit card 124. When these PCI bus connectors are so coupled to each other, circuitry 126B in circuit card 124 may become electrically coupled to bus 106. When circuitry 126B is electrically coupled to bus 106, any of host processors 102A, 102B, . . . , 102N may exchange data and/or commands with circuitry 126B via bus 106 that may permit one or more host processors 102A, 102B, . . . , 102N to control and/or monitor the operation of circuitry 126B. Network adapter 108 may comprise, for example, a NIC (network interface card). Rather than reside on circuit card 124, network adapter 108 may instead be comprised on system motherboard 118. Alternatively, network adapter 108 may be integrated into a chipset (not shown).

Network adapter 108 may comprise an indirection table 116 (labeled “IT”) to direct receive packets 140 to a receive queue 110A, . . . , 110N. Indirection table 116 may comprise one or more entries, where each entry may comprise a value based, at least in part, on receive packet 140, and where each value may correspond to a receive queue 110A, . . . , 110N. In an RSS environment, for example, indirection table 116 may comprise an RSS hash value and a corresponding receive queue 110A, . . . , 110N, where the RSS hash value may be based, at least in part, on a receive packet 140.

“Receive packets” received by a first system refer to packets received from another system, such as over a network, and by, for example, a network adapter. Receive packet 140 may comprise one or more fields, including one or more header fields 140A. One or more header fields may provide information, such as information related to a connection context. Receive packet 140 may additionally comprise a tuple 140C (hereinafter “packet tuple”). As used herein, a “tuple” refers to a set of values to uniquely identify a connection. A packet tuple, therefore, refers to a set of values in a packet to uniquely identify a connection. For example, the number of header fields of a receive packet 140 may be a 4-tuple (i.e. set of four values), for example, source TCP port, source IPv4 address, destination TCP port, and destination IPv4 address, which may be used to generate value 112, and to uniquely identify a connection associated with the receive packet 140.

Each receive queue 110A, . . . , 110N may store one or more receive packets 140 and may correspond to one of processors 102A, 102B, . . . , 102N that may process those one or more packets 140 on a given receive queue 110A, . . . , 110N. A given receive queue 110A, . . . , 110N that corresponds to a processor 102A, 102B, . . . , 102N means that a corresponding processor 102A, 102B, . . . , 102N may process receive packets 140 that are queued on the given receive queue 110A, . . . , 110N. Each receive queue 110A, . . . , 110N may queue receive packets 140 based on generated value 112.

Host memory 104 may store machine-executable instructions 130 that are capable of being executed, and/or data capable of being accessed, operated upon, and/or manipulated by circuitry, such as circuitry 126A, 126B. Host memory 104 may, for example, comprise read only, mass storage, random access computer-accessible memory, and/or one or more other types of machine-accessible memories. The execution of program instructions 130 and/or the accessing, operation upon, and/or manipulation of this data by circuitry 126A, 126B for example, may result in, for example, system 100 and/or circuitry 126A, 126B carrying out some or all of the operations described herein. Host memory 104 may additionally comprise one or more device drivers 134 (only one shown and described), operating system 132, table 138, and one or more receive queues 110A, . . . , 110N.

Device driver 134 may control network adapter 108 by initializing network adapter 108, and allocating one or more buffers (not shown) in a memory (such as host memory 104) to network adapters 108 for receiving one or more receive packets 140. Device driver 134 may comprise a NIC driver, for example.

Operating system 132 may comprise one or more protocol drivers 136 (only one shown and described). Protocol driver 136 may be part of operating system 132, and may implement one or more network protocols, also known as host stacks, to process receive packets 140. An example of a host stack is the TCP/IP (Transport Control Protocol/Internet Protocol) protocol. Protocol driver 136 on operating system 132 may also be referred to as a host protocol driver.

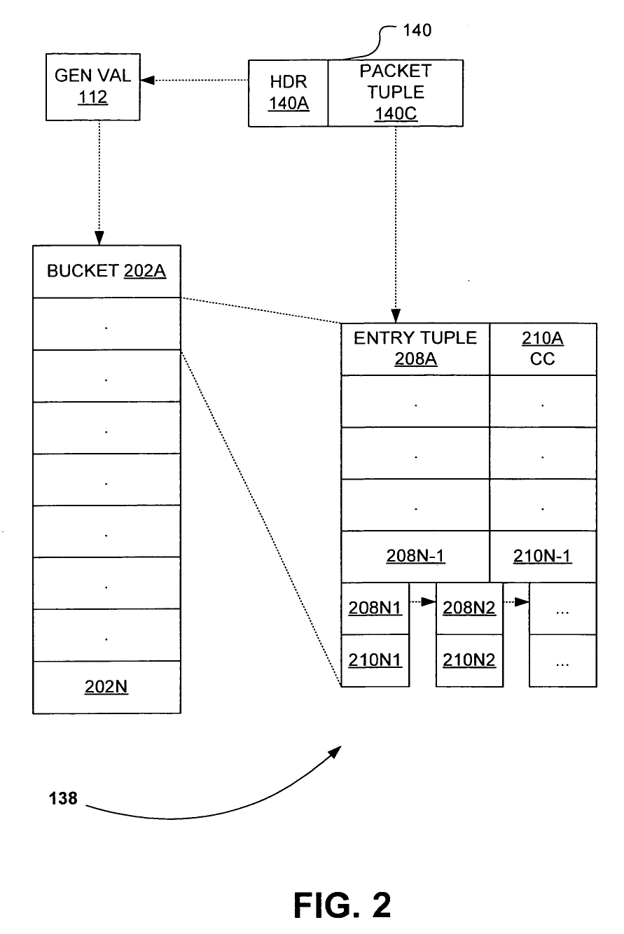

Table 138 may be used to determine a connection context associated with a receive packet 140. Referring now to FIG. 2, a table 138 may comprise one or more buckets 202A, . . . , 202N, where each bucket 202A, . . . , 202N may be mapped into using a generated value 112. Each bucket 202A, . . . , 202N may comprise one or more entries, where each entry may be identified by at least one tuple 208A, . . . , 208N (hereinafter “entry tuple”), and each tuple 208A, . . . , 208N may be mapped into using a packet tuple 140C. In an embodiment, table 138 may comprise a hash table having a plurality of hash buckets, where each hash bucket may comprise at least one entry identified by at least one entry tuple.

Each entry tuple 208A, . . . , 208N may be associated with a connection context 210A, . . . , 210N (labeled “CC”). In an embodiment, in an N-entry bucket 202A, . . . , 202N, the first N−1 entries 206A, . . . , 206N−1 may each comprise a connection context 210A, . . . , 210N associated with the entry tuple 208A, . . . , 208N, and the Nth entry 206N may comprise a linked list of one or more additional entry tuples 208N1, 208N2 and associated connection contexts 210N1, 210N2. The linked list may comprise pointers to different connection contexts 210N1, 210N2, and a connection context 210N1, 210N2 may be found using a linear search, for example, through the linked list. Of course, there may be variations of this without departing from embodiments of the invention. For example, all N entries 206A, . . . , 206N-1, 206N in a bucket 202A, . . . , 208N of N entries 206A, . . . , 208N may be mapped to a single entry tuple 208A, . . . , 208N-1, 208N, and a single connection context 210A, . . . , 210N−1, 210N.

In an embodiment, table 138 may be created when device driver 134 is initialized. In an embodiment, the generated value 112 may be used to create an entry in table 138 upon creation of a connection that may be offloaded. However, embodiments of the invention are not limited by this example, and it is possible that an entry in table 138 may be created for any connection that may be of interest in a particular implementation. For example, entries in table 138 may be created for connections with a particular system, connections associated with particular types of packets, or even every connection. Other possibilities exist.

As used herein, “offload” refers to transferring one or more processing tasks from one process to another process. For example, protocol processing of a receive packet 140 may be offloaded from a host stack to another process. A receive packet 140 that may be offloaded may be referred to as an offload packet. An “offload packet” refers to a receive packet in which processing of the receive packet may be offloaded from a host stack, and therefore, offloaded from processing by a host protocol driver.

Various criteria may be used to determine if a receive packet 140 may be an offload packet. For example, for a given receive packet 140, the receive packet 140 may be an offload packet if its packet characteristics are of a specified type, and if its associated connection context is of a certain type. Of course, different criteria, other criteria, or only a subset of the example criteria may be used to determine if a receive packet 140 may be an offload packet.

In an embodiment, protocol processing of a receive packet 140 may be offloaded to a TCP-A driver (Transport Control Protocol-Accelerated). A TCP-A driver may, for example, retrieve headers, parse the headers, performing TCP protocol compliance, and perform one or more operations that result in a data movement module, such as a DMA (direct memory access) engine, placing one or more corresponding payloads of packets into a read buffer. Furthermore, TCP-A may overlap these operations with packet processing to further optimize TCP processing. TCP-A drivers and processing are further described in U.S. patent application Ser. No. 10/815,895, entitled “Accelerated TCP (Transport Control Protocol) Stack Processing”, filed on Mar. 31, 2004. Offloading of protocol processing is not limited to TCP-A drivers. For example, protocol processing may be offloaded to other processes and/or components, including but not limited to, for example, a TOE (Transport Offload Engine).

Table 138 may be created to be of a large enough size so that when the maximum number of connection contexts 210A, . . . , 210N-1, 210N is offloaded, the table is no more than a specified percentage full. This may ensure that the table 138 will be sparsely filled so as to avoid collisions. Furthermore, table 138 may be created such that there are more buckets 202A, . . . , 202N than indirection table 132 entries, and the number of buckets 202A, . . . , 202N is a multiple of the number of indirection table 132 entries. This may ensure that all packets associated with a given bucket 202A, . . . , 202N will be associated with a single indirection table 132 entry. Consequently, every packet that results in the protocol driver 136 accessing a given bucket 202A, . . . , 202N may be processed on the same processor 102A, 102B, . . . , 102N. For example, if bucket 202A is associated with indirection table 132 entry A (entry not shown), and indirection table 132 A is associated with processor 102A, then all of the packets that may require protocol driver 136 to search bucket 202A may be processed by processor 102A.

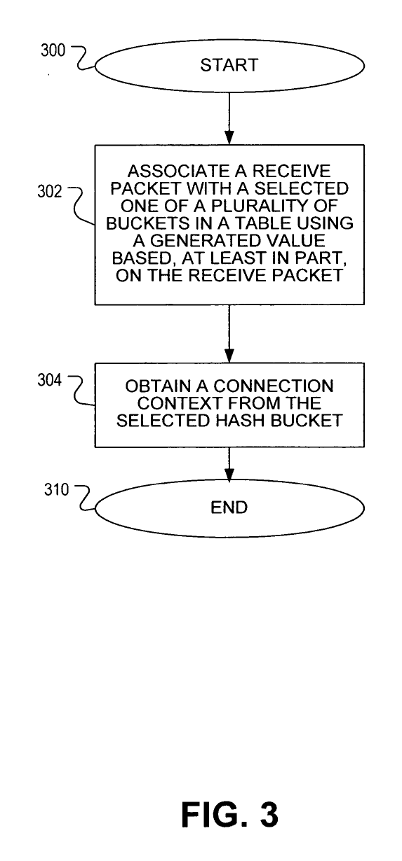

FIG. 3 illustrates a method in accordance with an embodiment of the invention. The method begins at block 300 and continues to block 302 where a receive packet 140 may be associated with one of a plurality of buckets 202A, . . . , 202N in a table 138 using a generated value 112 based on the receive packet 140. In an embodiment, receive packet 140 may be queued in a receive queue 110A, . . . , 110N based on generated value 112.

Receive packet 140 may be associated with one of a plurality of buckets 202A, . . . , 202N in a table 138 using a generated value 112 as follows. The bucket 202A, . . . , 202N to which receive packet 140 may be associated may be based, at least in part, on the generated value 112. In an embodiment, a subset of the generated value 112 may be used to associate receive packet 140 with a bucket 202A, . . . , 202N. For example, the subset may comprise some number of least significant bits of the generated value 112. Other possibilities exist. For example, the bucket 202A, . . . , 202N may be based, at least in part, on the generated value 112 by matching the entire generated value 112 to a bucket 202A, . . . , 202N. As another example, the bucket 202A, . . . , 202N may be based, at least in part, on the generated value 112 by performing a function, calculation, or other type of operation to on the generated value 112 to arrive at a bucket 202A, . . . , 202N. The method may continue to block 304.

In an embodiment, a preliminary check may be performed to determine if receive packet 140 may even be a candidate for offloading. For example, where various criteria may be used to make this determination, a preliminary check may be performed before associating a receive packet 140 with a bucket. For example, in an embodiment, a receive packet 140 may be a candidate for an offload packet if:

the packet 140 is a TCP packet;

the packet 140 is not an IP fragment;

the packet 140 does not include any IP options;

a URG (urgent) flag in the packet 140 is not set; and

a SYN (synchronized) flag in the packet 140 is not set.

In an embodiment, of the preliminary check does not pass, the receive packet 140 may instead be processed by host stack.

At block 304, a connection context 210A, . . . , 210N may be obtained from the bucket 202A, . . . , 202N. Once a bucket 202A, . . . , 20N is identified, a connection context 210A, . . . , 210N for the receive packet 140 may be obtained by finding a tuple match. A tuple match refers to a match between a packet tuple, and an entry tuple. A tuple match may be found either in a single entry having a single entry tuple, or in single entry having one or more additional entry tuples in a linked list, for example. Once a tuple match is found, the connection context 210A, . . . , 210N may be obtained. The method may continue to block 306.

The method may end at block 306.

In an embodiment, protocol driver 136 may perform the method of FIG. 3. Generated value 112 may be passed to protocol driver 136. Protocol driver 136 may use generated value 112 to prefetch a connection context 210A, . . . , 210N associated with receive packet 140 prior to a selected processor 102A, 102B, . . . , 102N processing one or more receive packets 140 from a receive queue 110A, . . . , 110N, and prior to the context actually being accessed by a particular protocol. Protocol driver 136 may make decisions on how to handle receive packets 140 associated with a particular connection context 210A, . . . , 210N. For example, in an embodiment, protocol driver 136 may transfer receive packets 140 associated with a particular connection context 210A, . . . , 210N to a TCP-A driver, for example, to perform accelerated processing if the particular connection context is specified to be an accelerated connection.

In an embodiment, such as in an RSS environment, network adapter 108 may receive a packet 140 (“receive packet”), and may generate an RSS hash value 112. This may be accomplished by performing a hash function over one or more header fields in the header 140A of the receive packet 140. One or more header fields of receive packet 140 may be specified for a particular implementation. For example, the one or more header fields used to determine the RSS hash value 112 may be specified by NDIS 5.2. Furthermore, the hash function may comprise a Toeplitz hash as described in the WinHEC Apr. 14, 2004 white paper.

A subset of the RSS hash value 112 may be mapped to an entry 206A, . . . , 206N in an indirection table 116 to obtain a result. The result may be added to another variable to obtain a value corresponding to a receive queue 110A, . . . , 110N located on host memory 104. The other variable may comprise, for example, a base processor number which may indicate the lowest number of processors that can be used in RSS, and which may be implementation-specific. The base processor number may be, for example, 0.

Network adapter 108 may transfer the packet 140 to the receive queue 110A, . . . , 110N corresponding to the RSS hash value 112. Device driver 134 may use configuration information to determine which processor 102A, 102B, . . . , 102N to use to process receive packets 140 on each receive queue 110A, . . . , 110N. Configuration information may be determined by RSS processing, and may include the set of processors on which receive traffic should be processed. This information may be passed down to the device driver 134 when RSS is enabled.

In an embodiment, prior to determining which processor 102A, 102B, . . . , 102N to use to process receive packets 140 on a given receive queue 110A, . . . , 110N, RSS hash value 112 may be passed to protocol driver 136 so that protocol driver 136 may obtain a connection context 210A, . . . , 210N associated with a given receive packet 140 as described in FIG. 3.

In an embodiment, RSS functionality may be enabled or disabled, for example, by host stack of operating system 132. However, it is possible that protocol driver 136 may instead specify that RSS be enabled even if host stack does not enable RSS. This way, protocol driver 136 may continue to prefetch connection contexts 210A, . . . , 210N without the need to rely on whether RSS is enabled. In this embodiment, the RSS hash value 112 would continue to be generated, but only one receive queue 110A, . . . , 110N and one processor 102A, 102B, . . . , 102N would be used.

### CONCLUSION

Therefore, in an embodiment, a method may comprise associating a receive packet with a selected one of a plurality of buckets in a table using a generated value based, at least in part, on the receive packet, and obtaining a connection context from the selected bucket.

Embodiments of the invention may enable connection contexts to be prefeteched by a protocol driver. By utilizing a value generated based on one or more headers of a receive packet, a protocol driver may determine a connection context associated with the receive packet. In an embodiment, this may optimize other processes, such as TCP acceleration.

In the foregoing specification, the invention has been described with reference to specific embodiments thereof. It will, however, be evident that various modifications and changes may be made to these embodiments without departing therefrom. The specification and drawings are, accordingly, to be regarded in an illustrative rather than a restrictive sense.

What is claimed is:

1. A method comprising:
associating a receive packet with a selected one of a plurality of buckets in a table using a generated value based, at least in part, on the receive packet; and
obtaining a connection context from the selected bucket.

2. The method of claim 1, additionally comprising:
determining if the packet is an offload packet prior to associating the receive packet with one of a plurality of buckets.

3. The method of claim 1, wherein:
the method is implemented using a Microsoft® Windows® operating system implementing RSS (Receive Side Scaling).

4. The method of claim 3, wherein:
the generated value comprises an RSS hash value that is generated by performing a hash function on one or more header fields of the receive packet.

5. The method of claim 4, wherein:
said associating a receive packet with one of a plurality of buckets comprises using a subset of the RSS hash value to associate the packet with one of the plurality of buckets.

6. The method of claim 1, wherein:
said obtaining a connection context from the selected bucket comprises finding a tuple match.

7. The method of claim 6, wherein each receive packet includes a packet tuple, and each of the one or more buckets in the table comprises one or more entries each having at least one entry tuple that is each associated with a connection context, and said finding a tuple match comprises:
matching the packet tuple to one of the at least one entry tuple.

8. The method of claim 7, wherein:
at least one of the one or more entries comprises a linked list of entries, each entry in the linked list having an entry tuple that is associated with a connection context.

9. An apparatus comprising:
circuitry to:
associate a receive packet with a selected one of a plurality of buckets in a table using a generated value based, at least in part, on the receive packet; and
obtain a connection context from the selected bucket.

10. The apparatus of claim 9, additionally comprising circuitry to:
determine if the packet is an offload packet prior to associating the receive packet with one of a plurality of buckets.

11. The apparatus of claim 9, wherein:
the circuitry is implemented using a Microsoft® Windows® operating system implementing RSS (Receive Side Scaling).

12. The apparatus of claim 11, wherein:
the generated value comprises an RSS hash value that is generated by performing a hash function on one or more header fields of the receive packet.

13. The apparatus of claim 12, wherein:
said associating a receive packet with one of a plurality of buckets comprises using a subset of the RSS hash value to associate the packet with one of the plurality of buckets.

14. The apparatus of claim 9, wherein:
said obtaining a connection context from the selected bucket comprises finding a tuple match.

15. The apparatus of claim 14, wherein each receive packet includes a packet tuple, and each of the one or more buckets in the table comprises one or more entries each having at least one entry tuple that is each associated with a connection context, and said finding a tuple match comprises: matching the packet tuple to one of the at least one entry tuple.

16. The apparatus of claim 15, wherein:
at least one of the one or more entries comprises a linked list of entries, each entry in the linked list having an entry tuple that is associated with a connection context.

17. A system comprising:
a circuit card coupled to a circuit board, the circuit card operable to generate a value (“generated value”) based, at least in part, on one or more header fields of a receive packet; and
circuitry communicatively coupled to the circuit card to:
associate the receive packet with a selected one of a plurality of buckets in a table using the generated value; and
obtain a connection context from the selected bucket.

18. The system of claim 17, wherein the generated value is used to determine which receive queue to use for processing the receive packet

19. The system of claim 17, wherein the generated value comprises a hash value.

20. The system of claim 19, wherein the hash value is generated by performing a hash algorithm on the one or more header fields of the receive packet.

21. The system of claim 17, wherein:
the circuitry is implemented using a Microsoft® Windows® operating system implementing RSS (Receive Side Scaling).

22. The system of claim 17, wherein:
the generated value comprises an RSS hash value that is generated by performing a hash function on one or more header fields of the receive packet.

23. The apparatus of claim 17, wherein:
said obtaining a connection context from the selected bucket comprises finding a tuple match.

24. An article of manufacture having stored thereon instructions, the instructions when executed by a machine, result in the following:
associating a receive packet with a selected one of a plurality of buckets in a table using a generated value based, at least in part, on the receive packet; and
obtaining a connection context from the selected bucket.

25. The article of claim 24, wherein the instructions additionally result in:
determining if the packet is an offload packet prior to associating the receive packet with one of a plurality of buckets.

26. The article of claim 24, wherein:
the method is implemented using a Microsoft® Windows® operating system implementing RSS (Receive Side Scaling).

27. The article of claim 26, wherein:
the generated value comprises an RSS hash value that is generated by performing a hash function on one or more header fields of the receive packet.

28. The article of claim 27, wherein:
said instructions that result in associating a receive packet with one of a plurality of buckets additionally result in using a subset of the RSS hash value to associate the packet with one of the plurality of buckets.

29. The article of claim 24, wherein:
said instructions that result in obtaining a connection context from the selected bucket additionally result in finding a tuple match.

30. The article of claim 29, wherein each receive packet includes a packet tuple, and each of the one or more buckets in the table comprises one or more entries each having at least one entry tuple that is each associated with a connection context, and said instructions that resulting finding a tuple match comprises:
instructions that result in matching the packet tuple to one of the at least one entry tuple.
